(19) United States
(12) Patent Application Publication
(10) Pub. No.: US 2017/0351743 A1
(43) Pub. Date: Dec. 7, 2017

(54) JOURNALING FOR SCALEOUT SYSTEMS

(71) Applicant: Portworx, Inc., Redwood City, CA (US)

(72) Inventors: Vinod Jayaraman, San Francisco, CA (US); Goutham Rao, Los Altos, CA (US)

(73) Assignee: Portworx, Inc., Redwood City, CA (US)

(21) Appl. No.: 15/173,547

(22) Filed: Jun. 3, 2016

(51) Int. Cl. G06F 17/30

(52) U.S. Cl. CPC G06F 17/30578

(57) ABSTRACT

According to various embodiments, techniques and mechanisms described herein may facilitate the resynchronization of storage container nodes within a storage volume. In some implementations, a virtual storage volume may be created by aggregating storage resources from two or more storage container nodes. Each storage container node may include a privileged storage container that runs atop a virtualization layer. For redundancy, a virtual storage volume may store the same data on two or more of the storage nodes that make up the volume. However, the data may become out-of-sync, for instance if one or more of the nodes fails during the execution of a storage operation. Data may be resynchronized after a node failure by designating data as source data for resynchronization based on comparing metadata across nodes in view of data integrity guarantees.

### TECHNICAL FIELD

The present disclosure relates generally to containerized applications and more specifically to containerized scalable storage applications.

### DESCRIPTION OF RELATED ART

One of the most difficult challenges facing software developers is interoperability of software between different computing environments. Software written to run in one operating system typically will not run without modification in a different operating system. Even within the same operating system, a software program may rely on other programs in order to function. Each of these dependencies may or may not be available on any given system, or may be available but in a version different from the version originally relied upon. Thus, dependency relationships further complicate efforts to create software capable of running in different environments.

In recent years, the introduction of operating-system-level virtualization has facilitated the development of containerized software applications. A system configured with operating-system-level virtualization includes a container engine that operates on top of the operating system. Importantly, the container engine is configured to operate interchangeably in different environments (e.g., with different operating systems). At the same time, the container engine is configured to present a standardized interface to one or more software containers.

Each software container may include computer programming code for performing one or more tasks. Examples of software containers include web servers, email servers, web applications, and other such programs. Each software container may include some or all of the software resources that the software in the container needs in order to function. For example, if a software container includes a web application written in the Python programming language, the software container may also include the Python programming language modules that the web application relies upon. In this way, the software container may be installed and may execute successfully in different computing environments as long as the computing environment includes a container engine.

### BRIEF SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide techniques and mechanisms for resynchronizing out-of-sync data stored on and among a plurality of storage container nodes. According to various embodiments, a request may be received to resynchronize a designated data portion stored on two or more storage container nodes that are each configured to store the designated data portion. A plurality of checksum values may be compared for equality, where each checksum value is associated with a respective one of the storage container nodes, with a respective timestamp, and with a respective version of the designated data portion. When it is determined that at least a first one of the plurality of checksum values does not match at least a second one of the plurality of checksum values, a designated one of the checksum values may be identified based on the timestamps. The storage container nodes may then be updated to each include the designated data portion.

In particular embodiments, identifying the designated checksum value may involve identifying the latest timestamp associated with a checksum value present on any storage container node. Alternately, identifying the designated checksum value may involve identifying the latest timestamp associated with a checksum value present on a designated number of the storage container nodes when it is determined that the system is configured to enforce stable writes. The designated number of the storage container nodes may be a majority of the storage container nodes or may be some other number of storage nodes.

According to various embodiments, a designated data portion may be transmitted in response to receiving a request for the designated data portion. The storage container nodes may be members of a storage container node cluster, which may include a plurality of data storage volumes. These volumes may include a designated data storage volume, which may include the two or more storage container nodes. The request for the designated data portion may be generated at a container application located at one of the storage container nodes. Alternately, the request for the designated data portion may be generated at a container application located at an application node outside the designated data storage volume.

In particular embodiments, each storage container node may include a storage container and a container engine. The container engine may be configured to provide a virtualized operating system mediating communications associated with one or more containerized applications. Alternately, or additionally, each storage container node may include a respective storage container configured to access a respective one or more storage devices accessible via the storage container node.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a scalable storage container node system, configured in accordance with one or more embodiments.

FIG. 2 illustrates an example of a storage container node, configured in accordance with one or more embodiments.

FIG. 3 illustrates an example of a method for executing a storage request.

FIG. 4 illustrates an example of a method for initializing a new storage container node within a storage container node cluster.

FIG. 5 illustrates an example of a server.

FIG. 6 illustrates an example of a method for storing data.

FIG. 7 illustrates an example of a method for resynchronizing data.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

According to various embodiments, techniques and mechanisms described herein may facilitate the resynchronization of storage container nodes within a storage volume. In some implementations, a virtual storage volume may be created by aggregating storage resources from two or more storage container nodes. Each storage container node may include a privileged storage container that runs atop a virtualization layer. For redundancy, a virtual storage volume may store the same data on two or more of the storage nodes that make up the volume. However, the data may become out-of-sync, for instance if one or more of the nodes fails during the execution of a storage operation. Data may be resynchronized after a node failure by designating data as source data for resynchronization based on comparing metadata across nodes in view of data integrity guarantees.

### Example Embodiments

Techniques and mechanisms described herein may facilitate the configuration of a scalable storage container node system. In some embodiments, a scalable storage container node system may allow application containers in a virtualized application system to quickly and directly provision and scale storage. Further, the system may be configured to provide one or more user experience guarantees across classes of applications.

According to various embodiments, the system may pool the capacity of different services into virtual storage volumes and auto-allocate storage as application storage traffic scales or bursts. For instance, a single virtual storage volume may include hundreds or thousands of terabytes of storage space aggregated across many different storage devices located on many different physical machines.

In some embodiments, storage containers may communicate directly with server resources such as hardware storage devices, thus reducing or eliminating unnecessary virtualization overhead. Storage containers may be configured for implementation in a variety of environments, including both local computing environments and cloud computing environments.

In some implementations, storage volumes created according to the techniques and mechanisms described herein may be highly failure-tolerant. For example, a virtual storage volume may include data stored on potentially many different storage nodes. A storage node may fail for any of various reasons, such as hardware failure, network failure, software failure, or server maintenance. Data integrity may be maintained even if one or more nodes that make up a storage volume fail during data storage operations.

In particular embodiments, data integrity may be maintained in part by storing data redundantly on different storage nodes within the same virtual storage volume. However, the data may become out-of-sync, for instance if one or more of the nodes fails during the execution of a storage operation. For example, consider the configuration in which the same data is stored on two different storage nodes for redundancy. In this example, suppose that a request to write data to the two nodes is received. Further suppose that the second node fails before the data is written to the second node but after the data is written to the first node. If the data to be written to the second node were stored in volatile memory at the second node, the data would no longer be synchronized across the two nodes even after the second node was reactivated.

In conventional systems, resynchronization of data across nodes is typically guaranteed by running a journaled or log-structured file system. Such file systems store each write request received by a storage volume to a circular buffer known as a log. Then, the data can be retrieved from the log if a failure occurs before the data can be completely written to the storage volume. Such file systems can guarantee complete data integrity in the event of most types of failure. However, such file systems have several substantial drawbacks. For instance, data write operations are much less efficient if data needs to be written to both a log and to a different, ultimate destination.

In addition, conventional systems use a log-based approach for local data recovery. However, data resynchronization in a distributed system may involve one or more additional guarantees. For example, the system may need to ensure that all acknowledged writes are stable and will survive crashes and reboots of one or more nodes and/or loss of storage on one of the nodes. As another example, the system may need to ensure that writes submitted by the application but not acknowledged may either succeed or fail. As yet another example, the system may need to acknowledge that once the data in such undecided case has been read back, subsequent reads will return the same data. In contrast to conventional systems, some techniques and mechanisms disclosed herein involve determining if a local write has been recorded to stable storage by recording the checksum of the data and comparing it with a computed checksum of the data on the disk.

According to various embodiments, techniques and mechanisms described herein avoid much of the cost associated with journaled and log-structured file systems while maintaining substantial data integrity guarantees. Rather than storing all of the data associated with a write request to a log, techniques and mechanisms described herein involve storing checksums and timestamps, which require much less storage space. Then data integrity guarantees may be provided by timing the acknowledge messages generated in response to a data write request.

A first configuration supports stable write operations. The system can guarantee complete data integrity by transmitting an acknowledgement message in response to a write request only after data has been written to a designated portion (e.g. a majority) of nodes. In the first configuration, the data received in response to a subsequent corresponding read request will be the same data included in the original write request as long as the acknowledgement message was transmitted, even in the event of a full or partial node failure.

A second configuration supports non-stable write operations but consistent data. The system can guarantee data consistency by transmitting an acknowledgement message in response to a write request after the data associated with the write request has been written into memory. In the second configuration, the data received in response to a subsequent corresponding read request may not be the same data included in the original write request if the system encountered a full or partial node failure before the data in the write request could be completely written to the volume. However, the data received in response to a subsequent corresponding read request will be consistent across different nodes, even in the event of a full or partial node failure.

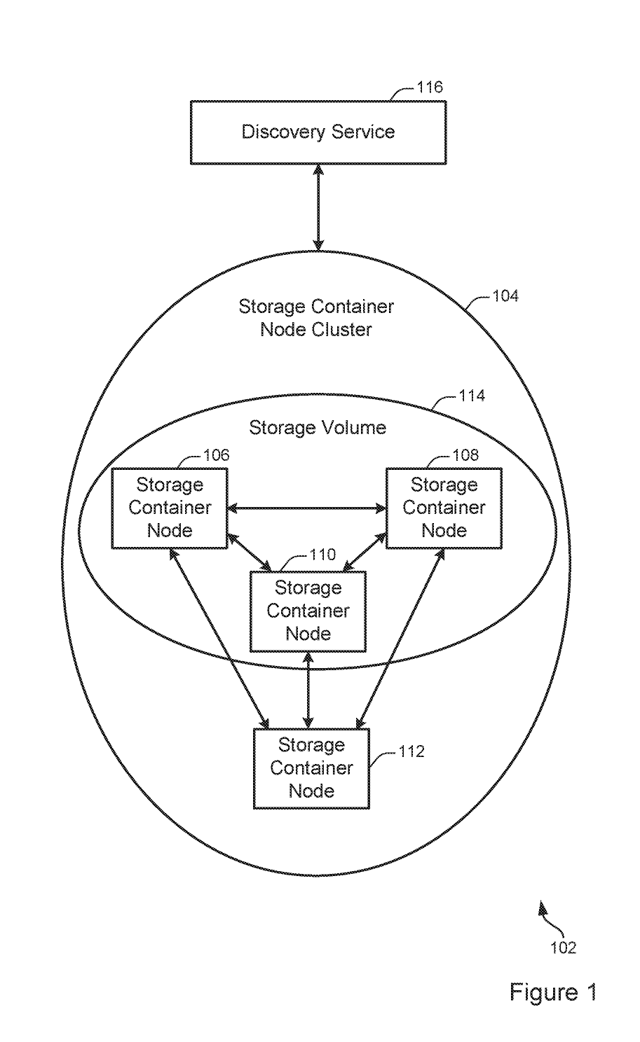

FIG. 1 illustrates an example of a scalable storage container node system 102. In some embodiments, the scalable storage container node system 102 may be capable of providing storage operations within the context of one or more servers configured to implement a container system. The scalable storage container node system 102 includes a storage container node cluster 104, which includes storage container nodes 106, 108, 110, and 112. The storage container nodes 106, 108, and 110 are combined to form a storage volume 114. The scalable storage container node system 102 also includes a discovery service 116.

At 104, the storage container node cluster 104 is shown. According to various embodiments, a storage container node cluster may include one or more storage container nodes collectively configured to aggregate and abstract storage resources for the purpose of performing storage-related operations. Although the scalable storage container node system 102 shows only a single storage container node cluster, implementations of the techniques discussed herein may frequently include thousands or millions of storage container node clusters in a scalable storage container node system.

At 106, 108, 110, and 112, storage container nodes are shown. A storage container node may be configured as discussed with respect to the storage container node 102 shown in FIG. 102 or may be arranged in a different configuration. Each storage container node may include one or more privileged storage container such as the privileged storage container 116 shown in FIG. 1.

According to various embodiments, storage container nodes may be configured to aggregate storage resources to create a storage volume that spans more than one storage container node. By creating such a storage volume, storage resources such as physical disk drives that are located at different physical servers may be combined to create a virtual volume that spans more than one physical server.

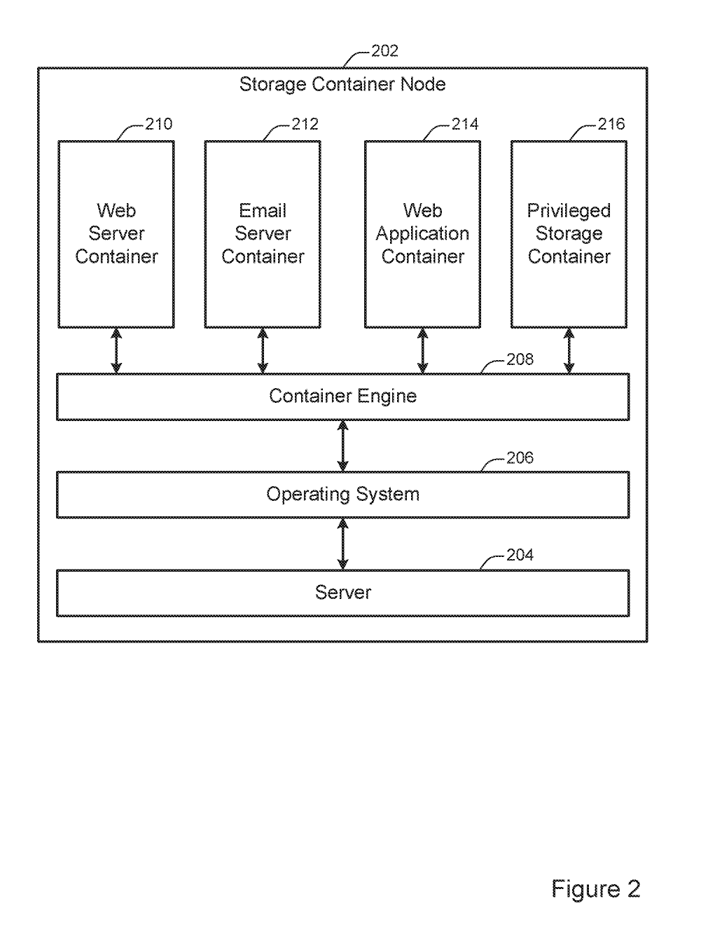

The storage volume may be used for any suitable storage operations by other applications. For example, the containers 210, 212, and/or 214 shown in FIG. 2 may use the storage volume for storing or retrieving data. As another example, other applications that do not exist as containers may use the storage volume for storage operations.

In some implementations, the storage volume may be accessible to an application through a container engine, as discussed with respect to FIG. 2. For instance, a privileged storage container located at the storage container node 106 may receive a request to perform a storage operation on a storage volume that spans multiple storage nodes, such as the nodes 106, 108, 110, and 112 shown in FIG. 1. The privileged storage container may then coordinate communication as necessary among the other storage container nodes in the cluster and/or the discovery service 116 to execute the storage request.

At 114, a storage volume is shown. According to various embodiments, a storage volume may act as a logical storage device for storing and retrieving data. The storage volume 114 includes the storage container nodes 106, 108, and 110. However, storage volumes may be configured to include various numbers of storage container nodes. A storage volume may aggregate storage resources available on its constituent nodes. For example, if each of the storage container nodes 106, 108, and 110 include 2 terabytes of physical data storage, then the storage volume 114 may be configured to include 6 terabytes of physical data storage.

In some implementations, a storage volume may provide access to data storage for one or more applications. For example, a software application running on any of storage container nodes 106-112 may store data to and/or retrieve data from the storage volume 114. As another example, the storage volume 114 may be used to store data for an application running on a server not shown in FIG. 1.

At 116, a discovery service is shown. According to various embodiments, the discovery service may be configured to coordinate one or more activities involving storage container node clusters and/or storage container nodes. For example, the discovery service may be configured to initialize a new storage container node cluster, destroy an existing storage container node cluster, add or remove a storage container node from a storage container node cluster, identify which node or nodes in a storage container node cluster are associated with a designated storage volume, and/or identify the capacity of a designated storage volume.

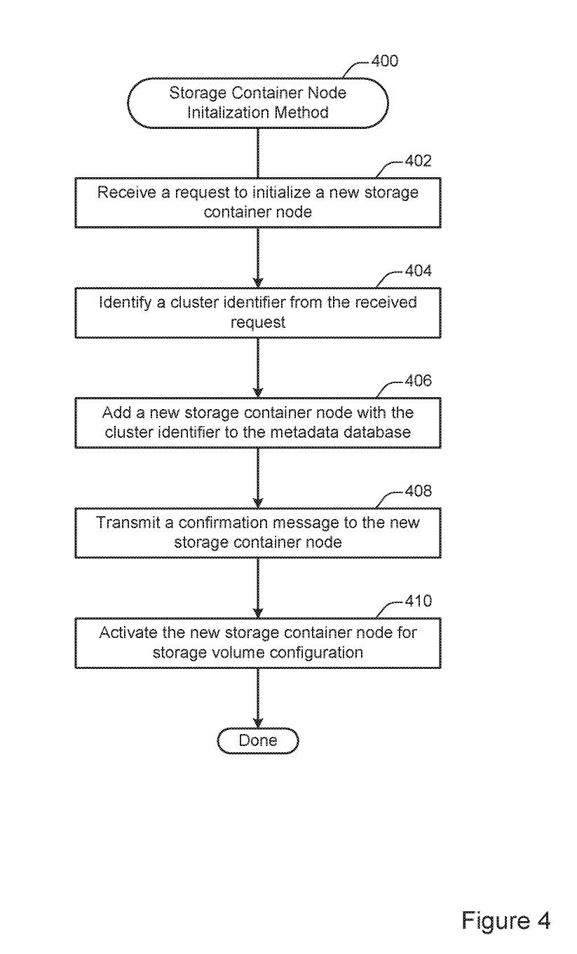

In some implementations, a discovery service may be configured to add a storage container node to a storage container node cluster. An example of such a method is described in additional detail with respect to FIG. 4. In some implementations, a discovery service may be configured to facilitate the execution of a storage request.

According to various embodiments, the discovery service may be configured in any way suitable for performing coordination activities. For instance, the discovery service may be implemented as a distributed database divided among a number of different discovery service node. The discovery service may include a metadata server that store information such as which storage container nodes correspond to which storage container node clusters and/or which data is stored on which storage container node. Alternately, or additionally, the metadata server may store information such as which storage container nodes are included in a storage volume.

FIG. 2 illustrates an example of a storage container node 202. According to various embodiments, a storage container node may be a server configured to include a container engine and a privileged storage container. The storage container node 202 shown in FIG. 2 includes a server layer 204, an operating system layer 206, a container engine 208, a web server container 210, an email server container 212, a web application container 214, and a privileged storage container 216.

In some embodiments, the storage container node 202 may serve as an interface between storage resources available at a server instance and one or more virtual storage volumes that span more than one physical and/or virtual server. For example, the storage container node 202 may be implemented on a server that has access to a storage device. At the same time, a different storage container node may be implemented on a different server that has access to a different storage device. The two storage nodes may communicate to aggregate the physical capacity of the different storage devices into a single virtual storage volume. The single virtual storage volume may then be accessed and addressed as a unit by applications running on the two storage nodes or at on another system.

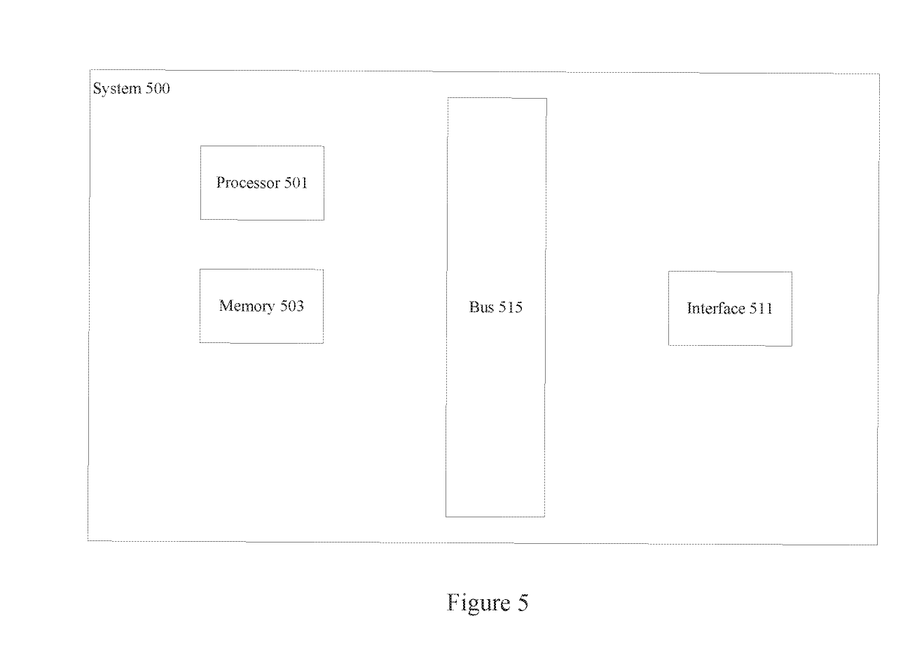

At 204, the server layer is shown. According to various embodiments, the server layer may function as an interface by which the operating system 206 interacts with the server on which the storage container node 202 is implemented. A storage container node may be implemented on a virtual or physical server. For example, the storage container node 202 may be implemented at least in part on the server shown in FIG. 5. The server may include hardware such as networking components, memory, physical storage devices, and other such infrastructure. The operating system layer 206 may communicate with these devices through a standardized interface provided by the server layer 204.

At 206, the operating system layer is shown. According to various embodiments, different computing environments may employ different operating system layers. For instance, a physical or virtual server environment may include an operating system based on Microsoft Windows, Linux, or Apple's OS X. The operating system layer 206 may provide, among other functionality, a standardized interface for communicating with the server layer 204.

At 208, a container engine layer is shown. According to various embodiments, the container layer may provide a common set of interfaces for implementing container applications. For example, the container layer may provide application programming interfaces (APIs) for tasks related to storage, networking, resource management, or other such computing tasks. The container layer may abstract these computing tasks from the operating system. A container engine may also be referred to as a hypervisor, a virtualization layer, or an operating-system-virtualization layer.

In some implementations, the separation of the computing environment into a server layer 204, an operating system layer 206, and a container engine layer 208 may facilitate greater interoperability between software applications and greater flexibility in configuring computing environments. For example, the same software container may be used in different computing environments, such as computing environments configured with different operating systems on different physical or virtual servers.

At storage container node may include one or more software containers. For example, the storage container node 202 includes the web server container 220, the email server container 212, and the web application container 214. A software container may include customized computer code configured to perform any of various tasks. For instance, the web server container 220 may provide files such as webpages to client machines upon request. The email server 212 may handle the receipt and transmission of emails as well as requests by client devices to access those emails. The web application container 214 may be configured to execute any type of web application, such as an instant messaging service, an online auction, a wiki, or a webmail service. Although that storage container node 202 shown in FIG. 2 includes three software containers, other storage container nodes may include various numbers and types of software containers.

At 216, a privileged storage container is shown. According to various embodiments, the privileged storage container may be configured to facilitate communications with other storage container nodes to provide one or more virtual storage volumes. A virtual storage volume may serve as a resource for storing or retrieving data. The virtual storage volume may be accessed by any of the software containers 220, 212, and 214 or other software containers located in different computing environments. For example, a software container may transmit a storage request to the container engine 208 via a standardized interface. The container engine 208 may transmit the storage request to the privileged storage container 216. The privileged storage container 216 may then communicate with privileged storage containers located on other storage container nodes and/or may communicate with hardware resources located at the storage container node 202 to execute the request.

In some implementations, one or more software containers may be afforded limited permissions in the computing environment in which they are located. For example, in order to facilitate a containerized software environment, the software containers 220, 212, and 214 may be restricted to communicating directly only with the container engine 208 via a standardized interface. The container engine 208 may then be responsible for relaying communications as necessary to other software containers and/or the operating system layer 206.

In some implementations, the privileged storage container 216 may be afforded additional privileges beyond those afforded to ordinary software containers. For example, the privileged storage container 216 may be allowed to communicate directly with the operating system layer 206, the server layer 204, and/or one or more physical hardware components such as physical storage devices. Providing the storage container 216 with expanded privileges may facilitate efficient storage operations such as storing, retrieving, and indexing data.

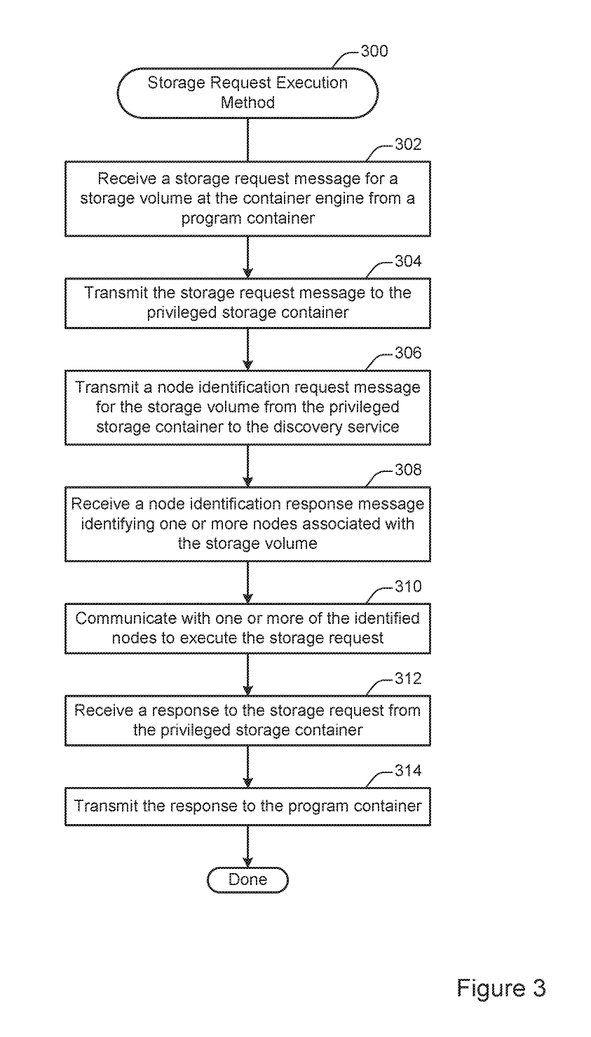

FIG. 3 illustrates an example of a method 300 for executing a storage request among components of a storage container node, performed in accordance with one or more embodiments. For example, the method 300 may be performed at a storage container node such as the node 202 shown in FIG. 2.

At 302, a storage request message for a data volume is received at the container engine from a program container. In some implementations, the storage request message may be received at the container engine 208 shown in FIG. 1 from any of the containers 210, 212, or 214 or any other program container.

According to various embodiments, the storage request message may include any request related to a data storage operation. For instance, the storage request may include a request to retrieve, store, index, characterize, or otherwise access data on a storage volume. The request may be transmitted from any container program configured to perform storage-related operations. For example, the web server container 210 shown in FIG. 2 may transmit a request to retrieve a file from a storage volume for the purpose of transmitting the file via a network. As another example, the email server container 212 may transmit a request to store a received email to a storage volume. As yet another example, the web application container 214 may transmit a request to identify the number and type of files in a folder on a storage volume.

At 304, the storage request is transmitted to the privileged storage container. For example, the container engine 208 may transmit the storage request to the privileged storage container 216 shown in FIG. 2.

According to various embodiments, the storage request may be received from the program container and/or transmitted to the privileged storage container via a standard API. For instance, the container engine 208 may support a standard storage API through which program containers may send and/or receive storage-related operations. Using a standard storage API may allow a program container to communicate interchangeably with different types of storage containers. Alternately, or additionally, using a standard storage API may allow a storage container to communicate interchangeably with different types of program containers.

At 306, a node identification request message is transmitted from the privileged storage container to the discovery service. In some implementations, the node identification request message may identify the storage volume associated with the storage request message. By communicating with the discovery service, the privileged storage container may identify which nodes in the cluster are associated with the storage volume.

At 308, a node identification response message is received at the privileged storage container from the discovery service. In some implementations, the node identification response message may identify one or more nodes associated with the storage volume. For example, if the privileged storage container located at the storage container node 112 shown in FIG. 1 transmitted a node identification request message to the discovery service identifying the storage volume 114, the node identification response message received from the discovery service may identify the storage container nodes 106, 108, and 110 shown in FIG. 1.

At 310, the privileged storage container may communicate with one or more of the identified nodes to execute the storage request. For example, the privileged storage container located at the storage container node 112 shown in FIG. 1 may access networking resources to communicate with one or more of the storage container nodes 106, 108, and 110. Communication may involve, for example, transmitting a file via the network to one or more of the nodes for storage.

In some instances, the privileged storage container may communicate with a single node. For instance, each node in the storage volume may be associated with a designated byte range or other subset of the data stored on the volume. The privileged storage container may then communicate with a particular storage container node to retrieve or store data that falls within the range of data associated with that node.

In some instances, the privileged storage container may communicate with more than one node. For example, the storage request may involve operations relating to data stored on more than one node. As another example, the storage volume may be configured for redundant data storage. In this case, executing a storage request to store data to the volume may involve transmitting storage messages to more than one volume.

At 312, a response to the storage request is received from the privileged storage container. At 314, the response is transmitted to the program container. According to various embodiments, the response may include any suitable information for responding to the storage request. For instance, the response may include a requested file, a confirmation message that data was stored successfully, or information characterizing data stored in a storage value.

In some implementations, the response may be received and requested in a manner similar to that discussed with respect to the receipt and transmission of the storage request discussed with respect to operations 302 and 304. For instance, the response may be received at the container engine 208 shown in FIG. 2 from the privileged storage container 216 and transmitted to the appropriate program container 210, 212, or 214.

FIG. 4 illustrates an example of a method 400 for initializing a new storage container node within a storage container node cluster, performed in accordance with one or more embodiments. The method 400 may be performed at a discovery service such as the discovery service 116 shown in FIG. 1.

At 402, a request to initialize a new storage container node is received. According to various embodiments, the request to initialize a new storage container node may be generated when a storage container node is activated. For instance, an administrator or configuration program may install a storage container on a server instance that includes a container engine to create a new storage container node. The administrator or configuration program may than provide a cluster identifier indicating a cluster to which the storage container node should be added. The storage container node may then communicate with the discovery service to complete the initialization.

At 404, a cluster identifier is identified from the received request. According to various embodiments, the cluster identifier may be included with the received request. Alternately, or additionally, a cluster identifier may be identified in another way, such as by consulting a configuration file.

At 406, a new storage container node with the cluster identifier is added to the metadata database. In some implementations, the metadata database may be implemented at the discovery service and may include various types of information for configuring the storage container node system. The metadata database may identify one or more clusters corresponding to each storage container node. For example, the metadata database may include a row of data that includes both the cluster identifier and an identifier specific to the new storage container node.

At 408, a confirmation message is transmitted to the new storage container node. According to various embodiments, the confirmation message may indicate to the new storage container node that initialization was successful and that the new storage container node is ready to be included in a storage container volume.

At 410, the new storage container node is activated for storage volume configuration. According to various embodiments, activating a storage container node for storage volume configuration may include responding to one or more requests to add the storage container node to a storage volume. For instance, an administrator or configuration program may transmit a request to the discovery service to add the new storage container node to a designated storage volume. The discovery service may then update configuration information in the metadata server to indicate that the designated storage volume includes the new storage container node. Then, the discovery service may direct subsequent requests involving the designated storage volume to the new storage container node or any other storage container node associated with the designated storage volume.

FIG. 5 illustrates one example of a server. According to particular embodiments, a system 500 suitable for implementing particular embodiments of the present invention includes a processor 501, a memory 503, an interface 511, and a bus 515 (e.g., a PCI bus or other interconnection fabric) and operates as a streaming server. When acting under the control of appropriate software or firmware, the processor 501 is responsible for modifying and transmitting live media data to a client. Various specially configured devices can also be used in place of a processor 501 or in addition to processor 501. The interface 511 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces. ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 500 is a server configured to run a container engine. For example, the system 500 may be configured as a storage container node as shown in FIG. 1. The server may include one or more hardware elements as shown in FIG. 5. In some implementations, one or more of the server components may be virtualized. For example, a physical server may be configured in a localized or cloud environment. The physical server may implement one or more virtual server environments in which the container engine is executed. Although a particular server is described, it should be recognized that a variety of alternative configurations are possible. For example, the modules may be implemented on another device connected to the server.

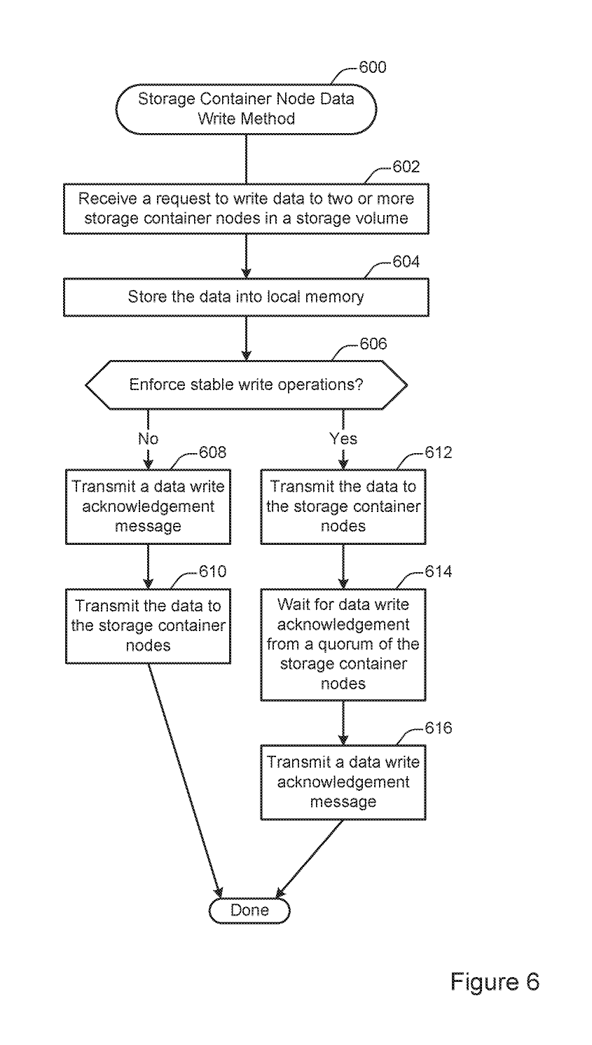

FIG. 6 illustrates an example of a storage container node data write method 600, performed in accordance with one or more embodiments. In some implementations, the method 600 may be implemented at a privileged storage container such as the container 216 shown in FIG. 2. The method 600 may be performed when storing data to a storage volume. For instance, the method 600 may be performed when communicating with nodes to execute a storage request as discussed with respect to operation 310 shown in FIG. 3.

At 602, a request is received to write data to two or more storage container nodes. According to various embodiments, the request may be received from an application container, such as one of the application containers 210, 212, or 214 shown in FIG. 2. The request may be received as part of a storage request execution method 300 shown in FIG. 3. In particular, the request may be received as part of an operation at a privileged storage container to communicate with one or more nodes, as discussed with respect to operation 310 in FIG. 10.

At 604, the data is stored into local memory. For instance, the data may be received from an application via a container engine. The data may be transmitted via a standardized storage API provided by the container engine for the purpose of storing, retrieving, or indexing data.

At 606, a determination is made as to whether to enforce stable write operations. In some implementations, whether to enforce stable write operations may be implemented as a system-level configuration option. For instance, an administrator or configuration program may indicate whether to enforce stable write operations across a storage volume, storage cluster, or storage system. Alternately, or additionally, whether to enforce stable write operations may be implemented as a parameter that may be included with a write request. For instance, an application may indicate that one write request should be stable, while a different write request may be non-stable.

In particular embodiments, whether to enforce stable write requests may reflect a tradeoff between data integrity and efficiency. Enforcing stable write requests may facilitate a greater level of data integrity guarantees at the cost of additional delay. For instance, enforcing stable write requests may result in the system being able to guarantee that the data returned when reading the result of an acknowledged write request is the same as the data included in the write request. However, enforcing stable write requests may cause a delay from the perspective of the application generating the write request.

At 608, if stable write operations are not enforced, a data write acknowledgement message is transmitted. For instance, the data write acknowledgement message may be transmitted even without confirming that the data has actually been written to the storage nodes. Transmitting the data write acknowledgment message may involve indicating to the application that generated the write request was received. For example, the data write acknowledgment message may be transmitted as discussed with respect from the privileged storage container to the application as discussed with respect to operations 312 and 314 in FIG. 3.

At 610, the data is transmitted to the storage container nodes. In some implementations, the data may be transmitted by sending the data from the storage container node at which the write request is generated to the nodes via a network interface. For example, the privileged storage container may transmit the write requests by directly access system resources for network transmission. As another example, the privileged storage container may transmit the write requests via an interface associated with the operating system or server layer.

At 612, if stable write operations are enforced, the data is transmitted to the storage container nodes. According to various embodiments, the transmission of the data to the storage container nodes at operation 612 may be substantially similar to the transmission of the data to the storage container nodes at operation 610.

At 614, the system waits until it receives acknowledgment from a quorum of the storage container nodes that they have received and stored the data. According to various embodiments, a quorum may be designated as a system configuration option. For instance, a quorum may be configured as a designated number of nodes, a relative majority of nodes, a simple majority of nodes, a supermajority of nodes, or a consensus of nodes. In particular embodiments, the definition of a quorum may depend at least in part upon factors such as the level of redundancy with which data is duplicated within the storage volume.

At 616, a data write acknowledgement message is transmitted. According to various embodiments, the transmission of a data write acknowledgement message at operation 616 may be substantially similar to the transmission of a data write acknowledgement message at operation 608.

According to various embodiments, when data is stored at a storage node, the storage node may record information indicating the storage of the data. The stored information may include, but is not limited to: a checksum or hash value representing the data that is stored, a timestamp indicating a date and time at which the data is stored, and an indication of a storage location associated with the data (e.g., a byte range or storage address).

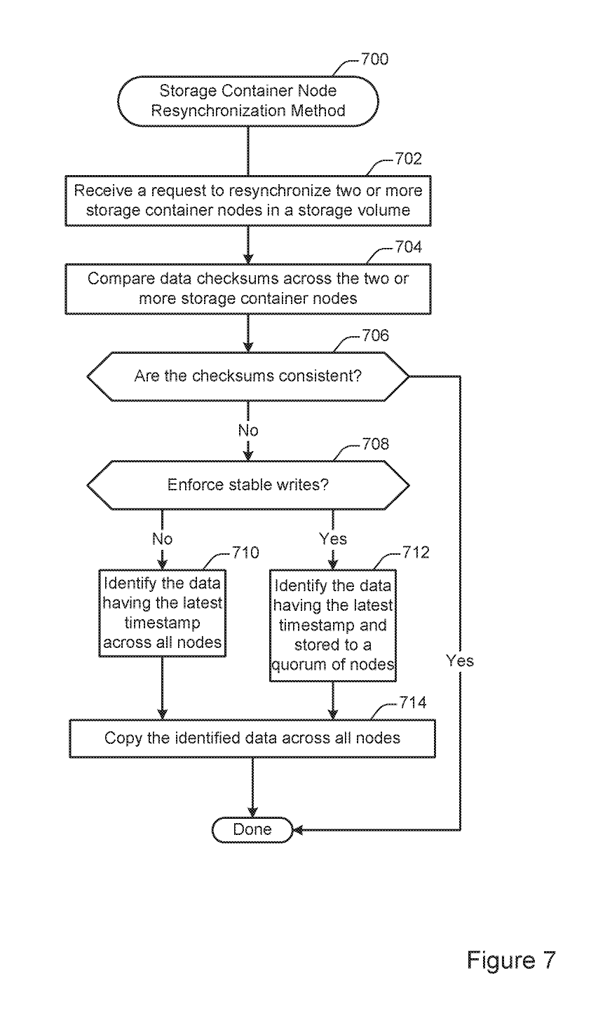

FIG. 7 illustrates a method of a storage container node resynchronization method 700, performed in accordance with one or more embodiments. In some implementations, the storage container node resynchronization method 700 may be performed when it is determined that a failure event has occurred. For example, the method may be performed when it is determined that communication has been restored or when a failed node has been reactivated. As another example, the method may be performed when a request for data is received after a failure event has been detected.

At 702, a request to resynchronized two or more storage container nodes is received. In some implementations, the request may be received at a storage container node tasked with facilitating the resynchronization. For example, the request may be received at a storage container node having a privileged storage container associated with the storage volume.

At 704, data checksums are compared across the two or more storage container nodes. According to various embodiments, comparing the data checksums may involve retrieving one or more data checksums from each data storage node. For instance, at least the most recent data checksum may be retrieved from each data storage node. In some implementations, additional data checksums may be retrieved as well.

In some implementations, retrieving the one or more data checksums may involve retrieving one or more additional pieces of information. For instance, a timestamp and/or data storage location associated with each data checksum may also be retrieved.

At 706, a determination is made as to whether the checksums are consistent across all nodes. According to various embodiments, the determination may be made by retrieving the checksums from each node and comparing them at a designated resynchronization node. If the checksums are consistent, then all of the nodes are storing the latest version of the data, so no further resynchronization need be performed.

At 708, a determination is made as to whether to enforce stable writes. According to various embodiments, the determination made at 708 may be substantially similar to the determination made at operation 606 in FIG. 6.

At 710, if stable writes are not enforced, then data is identified for replication across all of the nodes. The data that is identified may be the version of the data across all of the nodes that has the latest timestamp. For example, if a version of the data was last stored on one node two hours in the past and on another node only ten minutes in the past, the more recently-stored version of the data would be identified as the accepted version of the data. By identifying the latest version of the data as the single accepted version, the system can ensure that it provides the same data in response to a request for the data, regardless of the node that the data is retrieved from.

At 712, if stable writes are enforced, then data is again identified for replication across all of the nodes. In the event stable writes are enforced, the data that is identified may be the version of the data across all of the nodes that has the latest timestamp and that has also been copied to a quorum of the nodes. The number of nodes that represents a quorum may be identified as discussed with respect to operation 614 in FIG. 6. By identifying the latest version of the data stored to a quorum of the nodes as the single accepted version, the system can ensure that it provides the data acknowledged as stored in response to a request for the data, regardless of the node that the data is retrieved from.

At 714, the data identified as accepted in operations 710 or 712 is copied across all nodes. According to various embodiments, copying the data across all nodes may include any operations for transmitting the data from one or more nodes storing a copy of the accepted data to the nodes that are not storing the accepted version of the data.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
receiving a request to resynchronize a designated data portion stored on two or more storage container nodes, the two or more storage container nodes each configured to store the designated data portion;
comparing a plurality of checksum values for equality, each checksum value being associated with a respective one of the storage container nodes, with a respective timestamp, and with a respective version of the designated data portion;
when it is determined that at least a first one of the plurality of checksum values does not match at least a second one of the plurality of checksum values, identifying a designated one of the checksum values based on the timestamps; and
updating the two or more storage container nodes to each include the designated data portion.

2. The method recited in claim 1, wherein identifying the designated checksum value comprises identifying the latest timestamp associated with a checksum value present on any storage container node.

3. The method recited in claim 1, the method further comprising:
determining whether the system is configured to enforce stable data writes.

4. The method recited in claim 3, wherein identifying the designated checksum value comprises identifying the latest timestamp associated with a checksum value present on a designated number of the storage container nodes when it is determined that the system is configured to enforce stable writes.

5. The method recited in claim 4, wherein the designated number of the storage container nodes comprises a majority of the storage container nodes.

6. The method recited in claim 1, the method further comprising:
receiving a request for the designated data portion; and
transmitting the designated data portion in response to the request.

7. The method recited in claim 6, wherein the storage container nodes are members of a storage container node cluster, the storage container node cluster including a plurality of data storage volumes, the plurality of data storage volumes including a designated data storage volume, the designated data storage volume including the two or more storage container nodes.

8. The method recited in claim 6, wherein the request for the designated data portion is generated at a container application, the container application being located at one of the storage container nodes.

9. The method recited in claim 8, wherein the request for the designated data portion is generated at a container application, the container application being located at an application node outside the designated data storage volume.

10. The method recited in claim 1, wherein each storage container node includes a storage container and a container engine, the container engine being configured to provide a virtualized operating system mediating communications associated with one or more containerized applications.

11. The method recited in claim 1, wherein each storage container node includes a respective storage container configured to access a respective one or more storage devices accessible via the storage container node.

12. A system comprising:
a plurality of computing devices, each computing device including memory and at least one processor, each computing device including a network interface, the computing devices being configured to communicate over a network via the network interfaces, each computing device being configured to implement a storage container node, wherein a designated one of the storage container nodes is configured to:
receive a request to resynchronize a designated data portion stored on two or more of the storage container nodes, the two or more storage container nodes each configured to store the designated data portion;
compare a plurality of checksum values for equality, each checksum value being associated with a respective one of the storage container nodes, with a respective timestamp, and with a respective version of the designated data portion;
when it is determined that at least a first one of the plurality of checksum values does not match at least a second one of the plurality of checksum values, identify a designated one of the checksum values based on the timestamps; and
update the two or more storage container nodes to each include the designated data portion.

13. The system recited in claim 12, wherein identifying the designated checksum value comprises identifying the latest timestamp associated with a checksum value present on any storage container node.

14. The system recited in claim 12, wherein the designated storage container node is further configured to:
determining whether the system is configured to enforce stable data writes.

15. The system recited in claim 14, wherein identifying the designated checksum value comprises identifying the latest timestamp associated with a checksum value present on a designated number of the storage container nodes when it is determined that the system is configured to enforce stable writes.

16. The system recited in claim 15, wherein the designated number of the storage container nodes comprises a majority of the storage container nodes.

17. The system recited in claim 12, wherein the designated storage container node is further configured to:
receive a request for the designated data portion; and
transmit the designated data portion in response to the request.

18. One or more non-transitory computer readable media having instructions stored thereon for performing a method, the method comprising:
receiving a request to resynchronize a designated data portion stored on two or more storage container nodes, the two or more storage container nodes each configured to store the designated data portion;
comparing a plurality of checksum values for equality, each checksum value being associated with a respective one of the storage container nodes, with a respective timestamp, and with a respective version of the designated data portion;
when it is determined that at least a first one of the plurality of checksum values does not match at least a second one of the plurality of checksum values, identifying a designated one of the checksum values based on the timestamps; and
updating the two or more storage container nodes to each include the designated data portion.

19. The one or more non-transitory computer readable media recited in claim 18, wherein identifying the designated checksum value comprises identifying the latest timestamp associated with a checksum value present on any storage container node.

20. The one or more non-transitory computer readable media recited in claim 18, the method further comprising:
determining whether the system is configured to enforce stable data writes, wherein identifying the designated checksum value comprises identifying the latest timestamp associated with a checksum value present on a designated number of the storage container nodes when it is determined that the system is configured to enforce stable writes.
